(19) United States
(12) Patent Application Publication
(10) Pub. No.: US 2012/0111128 A1
(43) Pub. Date: May 10, 2012

(54) SAMPLING SYSTEM

(76) Inventor: Jörg Wisser, Sankt Georgen (DE)

(21) Appl. No.: 13/265,183

(22) PCT Filed: Apr. 19, 2010
(86) PCT No.: PCT/EP2010/002376

§ 371 Date: Dec. 23, 2011

(30) Foreign Application Priority Data
Apr. 22, 2009 (DE) 10 2009 018314.0

(51) Int. Cl. G01N 1/20

(52) U.S. Cl. 73/863.81

(57) ABSTRACT

A sampling system has a first connecting piece for connecting to a pipe traversed by fluid and a third connecting piece, and a cock which has a basic body with a longitudinal axis, about which the cock can be pivoted between a first end position and a second end position. The sampling system further has a sampling recess. In the first end position, the sampling recess can be connected via the first connecting piece to the pipe traversed by media. In the second end position, the sampling recess can be connected to the third connecting piece, in which the third connecting piece is connected to a first end of an extraction needle which can be pierced with a second end through a membrane of a sampling volume. In the second end position, the sampling recess is connected via the third connecting piece to a first end of a ventilation needle.

The invention relates to a sampling system according to the preamble of claim 1.

Sampling systems are known which have a first connecting piece, for connection to a pipe through which fluid flows, and a third connecting piece, via which the sampling can take place, and which furthermore have a cock, which has a main body with a longitudinal axis about which the cock can be pivoted between a first end position and a second end position, and a sampling recess, wherein, in the first end position, the sampling recess can be connected via the first connecting piece to the pipe through which fluid flows, and, in the second end position, the sampling recess can be connected to the third connecting piece. To carry out sampling, a drainage needle is connected by a first end to the third connecting piece and can be pushed with a second end through a membrane of a sampling volume. With the aid of such sampling systems, it is possible in particular to extract poisonous and environmentally hazardous fluids, since the extraction does not require opening of the pipe through which the fluid flows, and instead, during the operation, the sampling recess is simply filled with the fluid in the first end position and a defined volume of the fluid can then be extracted via the third connecting piece, wherein the fluid can flow through the extraction needle directly into the sampling volume, which is closed by the membrane, such that no external contact with the fluid occurs. The sampling system is therefore environmentally friendly and free of contamination. In particular, a representative sample can be extracted directly from the product line or bypass line.

Generally, in the second end position, the fluid can flow off in its entirety from the sampling recess into the sampling volume only if air can flow in at the same time. For this purpose, it is known to provide a ventilation line on an additional connecting piece of the sampling system, which ventilation line is connected either to the ambient air or, for contamination-free extraction, to a further needle that can be pushed at the same time as the extraction needle through the membrane into the sampling volume. When the cock moves to the second end position, the sampling volume is connected to the additional connecting piece, such that the sample can flow out of the sampling recess via the third connecting piece, while air or another gas can flow in through the additional connecting piece. However, for contamination-free extraction in particular, this design is of complex construction, since an additional connecting piece has to be present, and a ventilation line routed around the sampling system has to be provided from the additional connecting piece to the sampling volume.

The object of the invention is therefore to make available a sampling system of simpler construction.

According to the invention, the object is achieved by a sampling system with the features of claim 1.

Advantageous embodiments and refinements of the invention are set forth in the dependent claims.

The sampling system according to the invention, which has a first connecting piece, for connection to a pipe through which fluid flows, and a third connecting piece, and having a cock, which has a main body with a longitudinal axis about which the cock can be pivoted between a first end position and a second end position, and having a sampling recess, wherein, in the first end position, the sampling recess can be connected via the first connecting piece to the pipe through which fluid flows, and, in the second end position, the sampling recess can be connected to the third connecting piece, wherein the third connecting piece communicates with a first end of an extraction needle, which can be pushed with a second end through a membrane of a sampling volume, is characterized in that, in the second end position, the sampling recess communicates with a first end of a ventilation needle via the third connecting piece. According to the invention, both the extraction needle and also the ventilation needle thus communicate directly with the third connecting piece, such that there is no need for an additional connecting piece in the sampling system and no need for a ventilation line routed around the sampling system for contamination-free extraction.

According to a preferred embodiment of the invention, both the extraction needle and also the ventilation needle lie with their respective first end in a volume that communicates with the third connecting piece.

According to a preferred embodiment, the ventilation needle protrudes farther than the extraction needle into the volume, in order to ensure that, after the cock has moved to the second end position, the fluid flowing out of the sampling recess can flow off into the sampling volume via the extraction needle and does not close the ventilation needle.

The volume is preferably connected to the third connecting piece via a pipe, in particular a curved pipe section, in order to permit a variable installation of the sampling system into the fluid-conveying pipe.

The volume is preferably formed by a pipe piece, in order to predetermine a defined space.

According to a preferred embodiment of the invention, the first end of the ventilation needle is bent at an angle, particularly at an angle of approximately 90° to 180°, in order to ensure that the fluid emerging from the sampling recess does not flow into the ventilation needle.

According to a preferred embodiment of the invention, the sampling system has a second connecting piece lying in particular opposite the first connecting piece, the third connecting piece being offset at an angle with respect to the connecting axis of the first connecting piece and of the second connecting piece. In this way, it is possible to insert the sampling system directly into a pipe through which fluid flows and thus be able to extract a representative sample.

Preferably, the longitudinal axis of the main body, when the latter is inserted into the sampling system, extends substantially perpendicular to the connecting axis of the first connecting piece and of the second connecting piece, in order to achieve a particularly simple construction.

According to a particularly preferred embodiment of the invention, there is no connection of the first connecting piece to the third connecting piece and no connection of the second connecting piece to the third connecting piece in either of the end positions or any of the intermediate positions, in order in this way to be able to extract a defined sample volume and to permit sampling without pressure.

According to a preferred embodiment of the invention, the sampling recess is designed as a through-opening, wherein the first connecting piece and the second connecting piece can be connected via the through-opening in the first end position and the through-opening can be connected to the third connecting piece in the second end position, in order in this way to permit sampling directly from the sample stream.

A structurally simple design is obtained when the through-opening preferably extends substantially transversely with respect to the longitudinal axis of the cock.

An illustrative embodiment of the invention is explained in detail with reference to the attached figures, in which

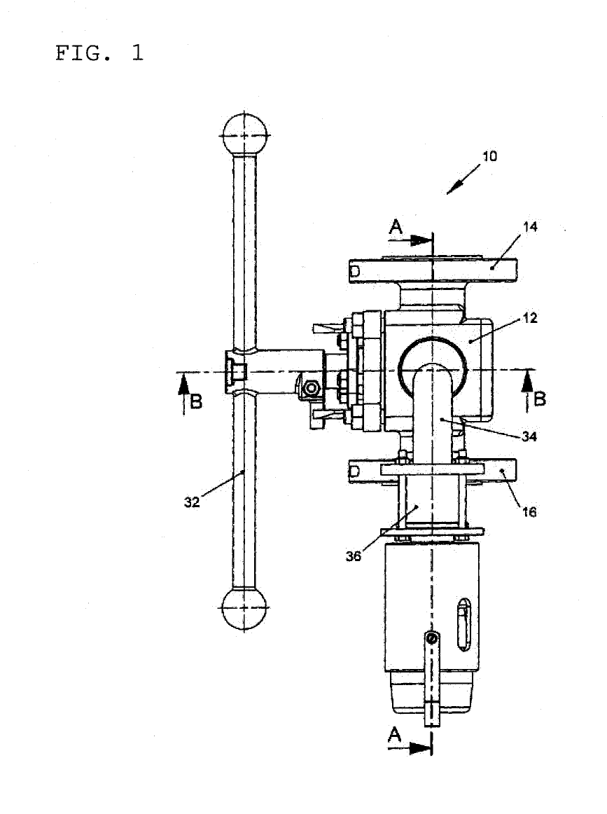

FIG. 1 shows a perspective view of an illustrative embodiment of a sampling system,

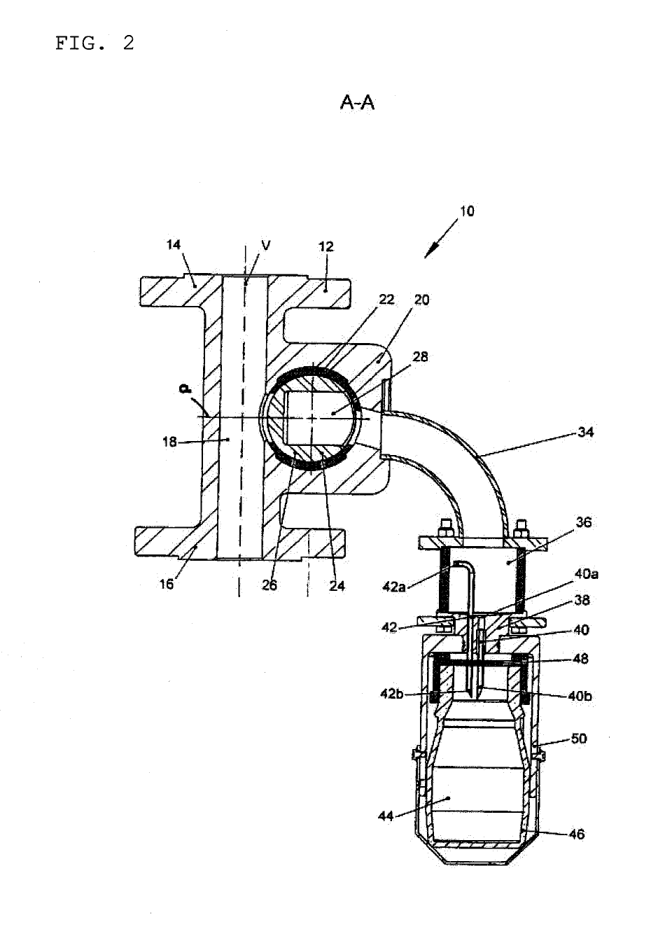

FIG. 2 shows a cross section along the line A-A in FIG. 1, and

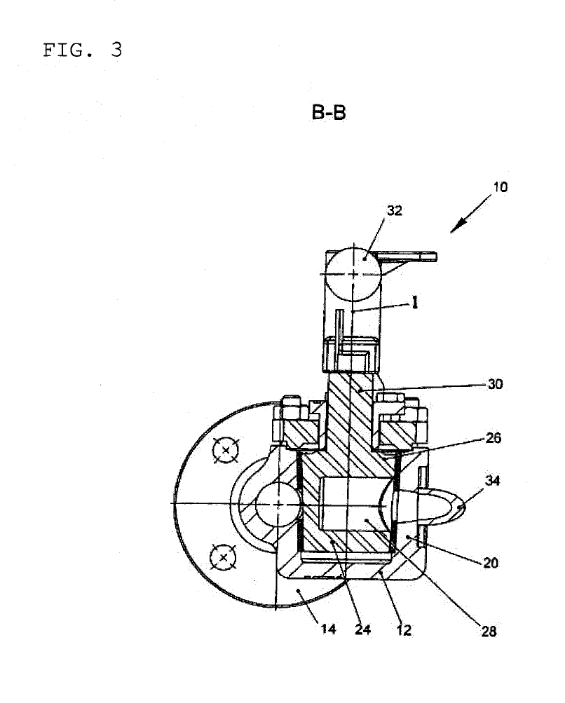

FIG. 3 shows a cross section along the line B-B in FIG. 1.

FIGS. 1 to 3 show different views of a sampling system 10. To make matters clearer, not all the reference signs are indicated in all the figures.

The sampling system 10 has a substantially cylindrical housing 12 with a first connecting piece 14 and a second connecting piece 16, which are connected via a substantially cylindrical connecting volume 18 that has a connecting axis v. Pipes through which fluid flows can respectively be connected to the first connecting piece 14 and to the second connecting piece 16, such that the housing becomes part of a pipe through which fluid flows. The sampling system 10 is used for sampling particularly in pipes through which liquid flows.

A connecting volume 22 with a longitudinal axis a extends inside the housing 12 transversely with respect to the connecting axis v and connects the connecting volume 18 to a third connecting piece 20. The connecting volume 22 has in particular a cavity in which a cock 24 with a main body 26 can be inserted in a pivotably mounted manner. The main body 26 has a longitudinal axis 1, which in particular extends transversely with respect to the connecting axis v and transversely with respect to the longitudinal axis a and around which the main body 26 is mounted pivotably between a first end position and a second end position. The main body 26 has a substantially conical shape. A sampling recess 28 is arranged in the main body 26, which sampling recess 28 terminates in an end face of the main body 26 and extends into the interior of the main body 26 transversely with respect to the longitudinal axis 1 of the main body 26. In the second end position of the cock 24, the sampling recess 28 is connected to the third connecting piece 20 (see in particular FIG. 2). In the first end position, the main body is turned through approximately 180° about its longitudinal axis 1, such that the sampling recess 28 communicates with the connecting volume 18 and thus with the first connecting piece 14 and the second connecting piece 16. To be able to easily turn the main body 26, a shaft 30 is arranged centrally on the main body 26 in the direction of the longitudinal axis 1, on which shaft 30 a grip 32 is arranged transversely with respect to the longitudinal axis 1.

To collect a sample, the cock 24 is first of all brought to the first end position, such that the liquid flowing through the pipe also fills the sampling recess 28. To be able to extract the sample, the cock 24 is pivoted through 180° such that the sampling recess 28 communicates with the third connecting piece 20 via which the defined sample volume can be extracted. The third connecting piece is adjoined first by a pipe section 34, which is connected at its other end to a volume 36. The pipe section 34 has a curved design in particular, in order to permit flexible installation.

The volume 36 is formed in particular by a cylindrical pipe with one end connected to the pipe section 34 via a flange, while a needle holder 38 is arranged at the other end. An extraction needle 40, which has a first end 40a and a second end 40b, is arranged in the needle holder 38 in such a way that the first end 40a lies in the volume 36, while the second end 40b lies outside the volume 36. The liquid flowing from the sampling recess 28 into the volume 36 can run out of the volume 36 via the extraction needle 40.

Arranged below the needle holder 38, there is a retainer 50 into which a sampling volume 44 can be inserted to collect the sample. The sampling volume 44 is designed in particular as a bottle 46, of which the opening is closed by a membrane 48. The membrane 48 can be pierced by the second end 40b of the extraction needle 40, but closes again as soon as the extraction needle 40 is withdrawn from the membrane 48, in order to reliably prevent escape of fluid from the sampling volume 44. Therefore, before the cock 24 is turned to the second end position, the sampling volume 44, for collecting the sample, is inserted into the retainer 50 and the extraction needle 40 is pushed with its second end 40b through the membrane 48.

To ensure that the sample to be extracted can flow off in its entirety from the volume 36 into the sampling volume 44, a ventilation needle 42 is provided, which has a first end 42a and a second end 42b and is arranged in such a way that its first end 42a lies in the volume 36, while the second end 42b is guided out of the volume 36. In particular, the second ends 40b, 42b of the extraction needle 40 and ventilation needle 42, respectively, terminate approximately at the same height, whereas the first end 42a of the ventilation needle 42 protrudes farther than the first end 40a of the extraction needle 40 into the volume 36. In particular, the first end 40a of the extraction needle 40 ends substantially flush with the inner surface of the needle holder 38. This ensures that the sample volume extracted can flow in its entirety out of the volume 36 via the extraction needle 40. However, particularly in the case of small flow cross sections, complete removal via the extraction needle 40 is ensured only if at the same time gas, in particular air, can flow back into the volume 36. The ventilation needle 42 serves this purpose. The fact that the ventilation needle 42 protrudes farther than the extraction needle 40 into the volume 36 ensures that the extracted sample flows off via the extraction needle 40 and not via the ventilation needle 42. The first end 42a of the ventilation needle 42 is bent at an angle of approximately 90° to 180°, in the present example of approximately 90°, in order to ensure that fluid flowing through the pipe section 34 cannot pass directly into the ventilation needle 42.

To permit sampling without pressure, there is no connection of the first connecting piece 14 to the third connecting piece 20 and no connection of the second connecting piece 16 to the third connecting piece 20 in either of the end positions or any of the intermediate positions. Therefore, between the first end position and the second end position, there is what is called a positive overlap, which ensures in particular that a defined sample volume is extracted.

### LIST OF REFERENCE SIGNS

10 sampling system
12 housing
14 first connecting piece
16 second connecting piece
18 connecting volume
20 third connecting piece
22 connecting volume
24 cock
26 main body
28 sampling recess
30 shaft
32 grip
34 pipe section
36 volume
38 needle holder
40 extraction needle
40a first end
40b second end
42 ventilation needle
42a first end
42b second end
44 sampling volume
46 bottle
48 membrane
50 retainer
l longitudinal axis
v connecting axis
a longitudinal axis

1. A sampling system, comprising:
a first connecting piece for connection to a pipe through which fluid flows and a third connecting piece;
a cock having a main body with a longitudinal axis about which the cock is pivotable between a first end position and a second end position; and
a sampling recess, wherein, in the first end position, the sampling recess is connectable via the first connecting piece to the pipe through which fluid flows, wherein, in the second end position, the sampling recess is connectable to the third connecting piece, wherein the third connecting piece communicates with a first end of an extraction needle, which is pushable with a second end through a membrane of a sampling volume, and wherein, in the second end position, the sampling recess communicates with a first end of a ventilation needle via the third connecting piece.

2. The sampling system as claimed in claim 1, wherein both the extraction needle and also the ventilation needle lie with their respective first ends in a volume that communicates with the third connecting piece.

3. The sampling system as claimed in claim 2, wherein the ventilation needle protrudes farther than the extraction needle into the volume.

4. The sampling system as claimed in claim 2, wherein the volume is connected to the third connecting piece via a pipe section.

5. The sampling system as claimed in claim 2, wherein the volume is formed by a pipe piece.

6. The sampling system as claimed in claim 1, wherein the first end of the ventilation needle is bent at an angle.

7. The sampling system as claimed in claim 1, further comprising:
a second connecting piece lying opposite the first connecting piece, the third connecting piece being offset at an angle with respect to the connecting axis of the first connecting piece and of the second connecting piece.

8. The sampling system as claimed in claim 7, wherein the longitudinal axis of the main body, when the latter is inserted into the sampling system, extends substantially perpendicular to the connecting axis of the first connecting piece and of the second connecting piece.

9. The sampling system as claimed in claim 1, wherein there is no connection of the first connecting piece to the third connecting piece and no connection of the second connecting piece to the third connecting piece in either of the end positions or any of the intermediate positions.

10. The sampling system as claimed in claim 7, wherein the sampling recess is a through-opening, wherein the first connecting piece and the second connecting piece are connectable via the through-opening in the first end position, and wherein the through-opening is connectable to the third connecting piece in the second end position.

11. The sampling system as claimed in claim 10, wherein the through-opening extends substantially transversely with respect to the longitudinal axis of the cock.

12. The sampling system as claims in claim 6, wherein the angle is approximately 90° to 180°.
